(19) United States
(12) Patent Application Publication
(10) Pub. No.: US 2023/0325244 A1
(43) Pub. Date: Oct. 12, 2023

(54) OBJECT PROCESSING METHOD AND APPARATUS, COMPUTER DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Kaimo HU, Shenzhen (CN); Shuhuai HUANG, Shenzhen (CN); Mengqi PENG, Shenzhen (CN)

(21) Appl. No.: 18/325,992

(22) Filed: May 30, 2023

Related U.S. Application Data
(63) Continuation of application No. PCT/CN2022/120055, filed on Sep. 21, 2022.

(30) Foreign Application Priority Data
Nov. 17, 2021 (CN) 202111359438.5

(51) Int. Cl. G06F 9/50

(52) U.S. Cl. CPC G06F 9/5027; G06F 9/5061

(57) ABSTRACT

An object information processing method includes: acquiring N resource objects to be added to a target container; performing grouping processing on the N resource objects to obtain a grouping processing result, the grouping processing result including at least two object groups and the cumulative area of each object group, the cumulative area of any object group being a sum of the area of all resource objects in the any object group, and a difference between the cumulative area of any two of the object groups being less than an area difference threshold; dividing the target container into at least two regions based on the grouping processing result, one object group corresponding to one region; and adding the N resource objects to the target container according to a corresponding relationship between the object groups and the regions.

### RELATED APPLICATION(S)

This application is a continuation application of PCT Patent Application No. PCT/CN2022/120055 filed on Sep. 21, 2022, which claims priority to Chinese Patent Application 202111359438.5 filed with the National Intellectual Property Administration on Nov. 17, 2021 and entitled “OBJECT PROCESSING METHOD AND APPARATUS, COMPUTER DEVICE, STORAGE MEDIUM, AND PROGRAM PRODUCT”, all of which are incorporated by reference in entirety.

### FIELD OF THE TECHNOLOGY

The present disclosure relates to the field of computer technologies, and in particular, to an object processing method and apparatus, a computing device, a storage medium, and a program product.

### BACKGROUND

With the continuous development of computer technology, efficiency may be improved by automatically solving a problem with a specific technology. When a packing problem is automatically solved based on the computer technology, the method used is to place a resource object to be added in a container according to a certain rule, and an available region of the container is updated after each placement until the container is filled with the resource object. In order to increase the adding speed, efficient use of hardware resources of a computing device is often involved. It is desirable to improve the packing efficiency of the resource object based on the hardware resources of the computing device.

### SUMMARY

In an aspect, an embodiment of the present disclosure provides an object processing method, performed by a computing device, including: acquiring N resource objects to be added to a target container, N being a positive integer greater than or equal to a threshold; performing, according to the value of N and the area of each resource object, grouping processing on the N resource objects to obtain a grouping processing result, the grouping processing result including at least two object groups and the cumulative area of each object group, the cumulative area of any object group being a sum of the area of all resource objects in the any object group, and a difference between the cumulative area of any two of the object groups being less than an area difference threshold; dividing the target container into at least two regions based on the grouping processing result, one object group corresponding to one region; and adding the N resource objects to the target container according to a corresponding relationship between the object groups and the regions.

In another aspect, an embodiment of the present disclosure provides an object processing apparatus, including: a memory storing computer program instructions; and at least one processor coupled to the memory and configured to execute the computer program instructions and perform: acquiring N resource objects to be added to a target container, N being a positive integer greater than or equal to a threshold; performing, according to the value of N and the area of each resource object, grouping processing on the N resource objects to obtain a grouping processing result, the grouping processing result comprising at least two object groups and the cumulative area of each object group, the cumulative area of any object group being a sum of the area of all resource objects in the any object group, and a difference between the cumulative area of any two of the object groups being less than an area difference threshold; dividing the target container into at least two regions based on the grouping processing result, one object group corresponding to one region; and adding the N resource objects to the target container according to a corresponding relationship between the object groups and the regions.

In still another aspect, an embodiment of the present disclosure provides a computing device, including a processor and a memory. The processor and the memory are interconnected, the memory is configured to store a computer-readable instruction, and the processing is configured to invoke the computer-readable instruction to perform the following steps: acquiring N resource objects to be added to a target container, N being a positive integer greater than or equal to a threshold; performing, according to the value of N and the area of each resource object, grouping processing on the N resource objects to obtain a grouping processing result, the grouping processing result including at least two object groups and the cumulative area of each object group, the cumulative area of any object group being a sum of the area of all resource objects in the any object group, and a difference between the cumulative area of any two of the object groups being less than an area difference threshold; dividing the target container into at least two regions based on the grouping processing result, one object group corresponding to one region; and adding the N resource objects to the target container according to a corresponding relationship between the object groups and the regions.

In yet another aspect, an embodiment of the present disclosure provides a non-transitory computer-readable storage medium. The computer-readable storage medium stores a computer-readable instruction. The computer-readable instruction, when executed by a processor, enables the processor to perform the object processing method as described in the first aspect.

A computer program product includes a computer-readable instruction. The computer-readable instruction, when executed by a processor, is used for implementing the object processing method as described in the first aspect.

Other aspects of the present disclosure may be understood by those skilled in the art in light of the description, the claims, and the drawings of the present disclosure.

### BRIEF DESCRIPTION OF THE DRAWINGS

To facilitate a better understanding of technical solutions of certain embodiments of the present disclosure, accompanying drawings are described below. The accompanying drawings are illustrative of certain embodiments of the present disclosure, and a person of ordinary skill in the art may still derive other drawings from these accompanying drawings without having to exert creative efforts. When the following descriptions are made with reference to the accompanying drawings, unless otherwise indicated, same numbers in different accompanying drawings may represent same or similar elements. In addition, the accompanying drawings are not necessarily drawn to scale.

FIG. 1a is a schematic diagram of a resource object according to certain embodiment(s) of the present disclosure.

FIG. 1b is one schematic diagram of adding a resource object to a target container according to certain embodiment(s) of the present disclosure.

FIG. 2 is a schematic flowchart of one object processing method according to certain embodiment(s) of the present disclosure.

FIG. 3 is another schematic diagram of adding a resource object to a target container according to certain embodiment(s) of the present disclosure.

FIG. 4 is a schematic flowchart of another object processing method according to certain embodiment(s) of the present disclosure.

FIG. 5 is a schematic diagram of adding a long and narrow polygon to a target container according to certain embodiment(s) of the present disclosure.

FIG. 6 is a flowchart of adding a resource object to a target container according to certain embodiment(s) of the present disclosure.

FIG. 7a is a schematic diagram of determining a center of gravity of a resource object according to certain embodiment(s) of the present disclosure.

FIG. 7b is one schematic diagram of determining an adding feasible region of a resource object according to certain embodiment(s) of the present disclosure.

FIG. 7c is another schematic diagram of determining an adding feasible region of a resource object according to certain embodiment(s) of the present disclosure.

FIG. 7d is a schematic diagram of deleting a concave vertex according to certain embodiment(s) of the present disclosure.

FIG. 7e is a schematic diagram of adjusting a convex segment as a vertex according to certain embodiment(s) of the present disclosure.

FIG. 8 is a schematic diagram after performing snap rounding on a resource object according to certain embodiment(s) of the present disclosure.

FIG. 9 is a schematic block diagram of an object processing apparatus according to certain embodiment(s) of the present disclosure.

FIG. 10 is a schematic block diagram of a computing device according to certain embodiment(s) of the present disclosure.

### DESCRIPTION OF EMBODIMENTS

To make objectives, technical solutions, and/or advantages of the present disclosure more comprehensible, certain embodiments of the present disclosure are further elaborated in detail with reference to the accompanying drawings. The embodiments as described are not to be construed as a limitation to the present disclosure. All other embodiments obtained by a person of ordinary skill in the art without creative efforts shall fall within the protection scope of embodiments of the present disclosure.

When and as applicable, the term “an embodiment,” “one embodiment,” “some embodiment(s), “some embodiments,” “certain embodiment(s),” or “certain embodiments” may refer to one or more subsets of embodiments. When and as applicable, the term “an embodiment,” “one embodiment,” “some embodiment(s), “some embodiments,” “certain embodiment(s),” or “certain embodiments” may refer to the same subset or different subsets of embodiments, and may be combined with each other without conflict.

In certain embodiments, the term “based on” is employed herein interchangeably with the term “according to.”

In a related technology, when a resource object is added to a target container, generally, one resource object is taken out and added to the target container in sequence according to an adding sequence of various resource objects; and after the resource object is added to the target container each time, a remaining region, which may be used for placing the resource object, of the target container is updated, and another resource object is taken out for adding based on the remaining region. Iteration is performed like this. Apparently, in this recursive manner, when the scale of the resource object is larger and larger, the recursion depth is greater and greater, and the running efficiency is lower and lower, which leads to low object processing efficiency.

The embodiment of the present disclosure provides an object processing method. When large-scale resource objects are added to the target container, a computing device performs grouping processing on the large-scale resource objects and the target container to obtain a plurality of object groups and regions corresponding to various object groups. Further, the computing device converts a process of adding the large-scale resource objects to the target container into a process of adding the resource object in each object group to the corresponding region, so that the efficiency of effectively adding the large-scale resource objects to the target container can be improved.

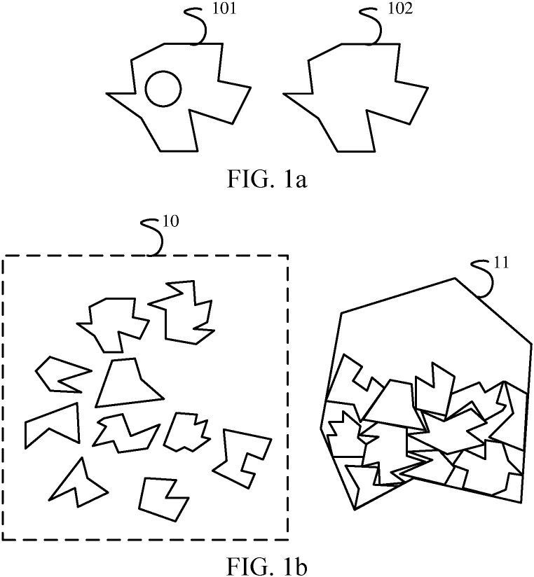

In one embodiment, the resource object is a polygonal two-dimensional object (called a polygon for short). The resource object referred to in the embodiment of the present disclosure is a closed polygon. The closed polygon may be a polygon with holes, as shown by the polygon marked by 101 in FIG. 1a. The resource object may also be a polygon without holes, as shown by the polygon marked by 102 in FIG. 1a. The target container may be configured to carry the resource object. The resource object may be stored in the target container after being added to the target container. For example, the resource object may be a UV island in a game production industry, and the UV island is essentially the polygon.

In certain embodiment(s), both the target container and the resource object refer to polygonal two-dimensional objects. The resource object in a shape of a polygon may be obtained by performing two-dimensional unfolding on a three-dimensional mode of a virtual object. For example, the resource object in a shape of a polygon may be a polygon, such as a triangle or a quadrangle obtained after the two-dimensional unfolding and partitioning are performed on the three-dimensional model. The resource object in a shape of a polygon may also be obtained by performing unfolding and partitioning processing on an actual object. The target container in a shape of a polygon refers to a polygon corresponding two a two-dimensional object configured to carry and store a resource object, for example, may be a polygon corresponding to a texture pictured for carrying and storing the two-dimensional polygon obtained by unfolding the three-dimensional model. The target container may also be a polygon for carrying a polygon corresponding to an actual portioning object. In the embodiment of the present disclosure, no limits are made to the manners of obtaining the resource object and the target container in a shape of a polygon.

In one embodiment, the virtual object may be a virtual object in a game scenario, for example, a virtual character, a virtual animal, and a virtual plant in the game scenario, and the virtual object displayed in the game scenario is obtained by performing texture mapping on the three-dimensional model of the virtual object through a texture mapping technology, so that the authenticity and vividness of the virtual object displayed in a game screen can be improved. A texture refers to a picture that can carry any information. UV mapping (a coordinate mapping method) (a coordinate mapping method) refers to that a UV coordinate value attached to a vertex of a three-dimensional model represents a position of a pixel sampled on the texture. The combination of the texture and the UV mapping is referred to texture mapping.

The texture mapping processing performed on the three-dimensional model by the computing device involves three steps such as surface patch segmentation, UV island generation (that is, resource object generation), and packing (that is, adding the resource object to the target container). In a specific implementation, after obtaining the three-dimensional model of the virtual object, the computing device may segment a surface of the three-dimensional model first to obtain a plurality of surface patches. The surface patch obtained by segmenting the surface of the three-dimensional model refers to a region formed by connecting surfaces of the three-dimensional model. It is to be understood that the surface patches obtained by segmenting the surface of the three-dimensional model by the computing device are also three-dimensional. Through the process of segmenting the three-dimensional model, the computing device may obtain the plurality of surface patches corresponding to the three-dimensional model. Further, the computing device may calculate a two-dimensional UV island corresponding to each surface patch, to flatten each surface patch into a two-dimensional plane. It is to be understood that the two-dimensional UV island corresponding to the surface patch obtained by the computing device is a two-dimensional polygon, that is, a resource object that is acquired by the computing device and that is to be added to a target container. The target container refers to a polygon corresponding to a texture picture. Then, after obtaining the two-dimensional UV island corresponding to each surface patch, the computing device may closely add (pack) the obtained UV island to the texture picture to add corresponding texture information for the three-dimensional model of the virtual object, so that the computing device is more realistic when displaying the three-dimensional model of the virtual object.

When the computing device closely adds the obtained UV island to the texture picture, in order to improve the adding efficiency, the computing device may first group a plurality of UV islands obtained to obtain a plurality of object groups, and perform region division on the texture picture serving as the target container, so that the UV island in each object group may be added to a corresponding region of the texture picture.

In one embodiment, the virtual object may be a virtual character and the like displayed on a social interface in a social scenario, and when the computing device displays the virtual character on the social interface, it may also be implemented by performing segmentation, two-dimensional flattening conversion, and packing on a three-dimensional model of the virtual character. During packing, a packing process of the resource object may be accelerated by grouping the resource object groups obtained by the two-dimensional flattening conversion and performing region division on the texture picture serving as the target container.

In one embodiment, the embodiment of the present disclosure may also be applied to various scenarios such as cloud technology, artificial intelligence, smart transportation, and assisted driving. The computing device may be a terminal device or a server. When the computing device is a terminal device, the terminal device may include, but is not limited to, mobile phones, computers, smart voice interaction devices, smart home appliances, vehicle terminals, and portable wearable devices. When the computing device is a server, the computing device may be implemented using independent servers or a server cluster composed of a plurality of servers.

In one embodiment, a process of adding a resource object to a target container is a packing process for the resource object. The packing process (or referred to as a packing problem) refers to arranging a group of regular or irregular two-dimensional or three-dimensional objects in a given regular or irregular container according to a certain rule, to achieve a specific purpose. The embodiment of the present disclosure focuses on packing a two-dimensional irregular polygon in a two-dimensional container, that is, both the resource object and the target container are two-dimensional, and processing processes for the resource object and the target container are also two-dimensional processing processes, which may be as shown in FIG. 1b. In FIG. 1b, any polygon in a dashed box marked by 10 is a resource object, and a heptagon marked by 11 is a target container. In one embodiment, when the resource object and the target container are three-dimensional objects, the computing device may perform packing processing by using the object processing method provided by the embodiment of the present disclosure after performing two-dimensional mapping processing on the three-dimensional resource object or target container based on a conversion relationship (for example, a projection relationship) between a three-dimensional object and a two-dimensional object. The object processing method provided by the embodiment of the present disclosure processes large-scale resource objects. The large-scale refers to that a large quantity of resource objects may be added to the target container. It is generally considered as large-scale when the quantity of the resource objects is greater than a threshold, while the threshold may be 100, 200, or the like. The threshold may be preset by the computing device. The threshold supports adjustment. It is to be understood that the conditions that the computing device triggers the grouping of the resource object and the grouping of the target container are different by setting different thresholds. In order to encourage super-large-scale partitioning as much as possible, the setting of this threshold may be relaxed.

In one embodiment, if the scale of the resource object acquired by the computing device is small (that is, a total quantity of the resource objects is small, for example, the total quantity of the resource objects is less than a threshold), the computing device may not divide the small-scale resource objects and the target container, when small-scale resource objects are added to the target container, the computing device may take out a resource object and add the same to the target container in sequence after determining an adding sequence of various resource objects, update a remaining region that is of the target container and that may be used for placing the resource object after the resource object is added to the target container each time, and take out another resource object for adding based on the remaining region. Iteration is performed like this until the small-scale resource objects are added to the target container.

In one embodiment, there may be a scenario that all resource objects are incapable of being successfully added to the target container when the computing device adds the resource object to the target container, and the computing device may stop adding the resource objects in this scenario, or the computing device may re-divide the resource objects first and perform a subsequent adding process in this scenario. For example, the computing device re-divides the resource objects in a target shape into a plurality of resource objects, and performs adding based on the resource objects obtained by re-dividing. The resource object in the target shape refers to a polygon with the length much greater than the width or with the width much greater than the length, for example, a long and narrow polygon; and the much greater refers to a significant difference in proportion, for example, it may be considered as much greater in response to that the proportion is 5 times or 10 times.

In one embodiment, after the computing device divides the large-scale resource objects and the target container to obtain a plurality of object groups and a region that may be added, the computing device adds the resource objects included in each object group into corresponding region in a serial adding manner. That is, the computing device may select one object group from the plurality of object groups obtained for adding the resource object each time, and selects another object group for adding the resource object after the resource object in the selected object group is added to the corresponding region. The computing device may determine that the serial adding process of the large-scale resource objects is performed until the adding process is performed on the resource objects in each object group. In another implementation mode, after obtaining a plurality of object groups and corresponding regions, the computing device adds the resource objects in each object group to the corresponding region in a parallel adding manner, that is, the computing device concurrently adds the resource objects in each object group to the corresponding region of the target container. Practice shows that after the computing device divides the large-scale resource objects and the target container, no matter the serial adding manner or parallel adding manner is used for performing an adding process of the resource objects, the filling rate of the target container when the computing device adds the resource objects can be ensured, and meanwhile, the adding process is accelerated, so that the computing device can achieve a better acceleration effect on the basis of ensuring the filling rate. Therefore, the computing device adopts a processing process of dividing the resource objects and the target container first, and adding the resource objects to the target container, which can effectively improve the efficiency of adding the resource objects to the target container.

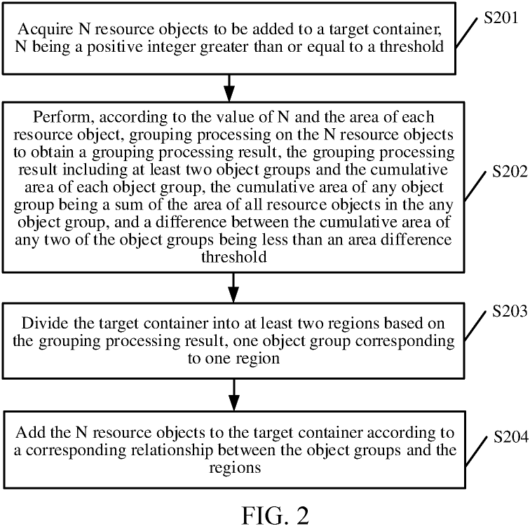

Refer to FIG. 2, which is a schematic flowchart of an object processing method provided by an embodiment of the present disclosure. As shown in FIG. 2, the method may include the following steps:

S201: Acquire N resource objects to be added to a target container. N is a positive integer greater than or equal to a threshold.

S202: Perform, according to the value of N and the area of each resource object, grouping processing on the N resource objects to obtain a grouping processing result. The grouping processing result includes at least two object groups and the cumulative area of each object group. The cumulative area of any object group is a sum of the area of all resource objects in the any object group. A difference between the cumulative area of any two of the object groups is less than an area difference threshold.

In response to that the scale of the resource objects to be added (or to be packed) is too large, that, a quantity of the resource objects exceeds a threshold (the threshold may be 100, 200, or the like), running efficiency when the computing device performs packing is low. Just because the quantity of the resource objects tends to be large, the filling rate of packing results after the computing device adds the resource objects to the target container tends to be high, so the efficiency of packing the large-scale resource objects by the computing device may be improved by sacrificing a little bit of the filling rate of the target container in step S201 and step S202. Therefore, in order to effectively improve the efficiency of adding the large-scale resource objects to the target container, the computing device may group the resource objects reasonably first and simultaneously divides a packing region (that is, the target container) correspondingly, and the computing device may add the object groups obtained by grouping the resource objects to the corresponding regions, to improve the efficiency of adding the resource objects to the target container by the computing device.

Due to a large quantity, different sizes, and different shapes of the resource objects acquired by the computing devices, in order to ensure high filling rate for the target container after the computing device adds the resource objects to the target container and to ensure the uniformity of overall distribution of the resource objects in the target container after the computing device adds the resource objects to the target container, the computing device may perform grouping based on the following scenario (1) and scenario (2) when performing grouping processing on the resource objects:

(1) The resource objects with large area are grouped into different object groups as much as possible, to reduce the packing pressure of each object group. In certain embodiment(s), when there are a plurality of resource objects with large area in the object group, it is not beneficial to adding the resource objects in the object group to the corresponding regions.

(2) The cumulative area (that is, a sum of the area of all resource objects included in each object group) of each object groups is made close as much as possible, so that the space division for the target container is uniform, and the time taken by the computing device to add the resource objects in each object group to the corresponding region may also be kept generally consistent.

Based on the scenario (1) and scenario (2), after the computing device performs grouping processing on the N resource objects, the difference between the cumulative area of any two of the object groups may be less than an area difference threshold, that is, the cumulative area of the object groups obtained by dividing is close. In one embodiment, the area of any resource object refers to the area of the polygon corresponding to the resource object. In response to that the polygon includes holes, the area of the resource object is the area obtained by subtracting the area of the holes from the area of the polygon. In addition, if the computing device cannot equally divide the resource objects based on the cumulative area of the resource objects, the computing device may perform equal-ratio division based on the cumulative area of the object groups obtained by grouping the resource objects when dividing the target container, so that each region obtained by dividing the target container is close to an expansion factor of a corresponding resource group, which can effectively ensure the rationality of adding the resource objects to the corresponding region subsequently.

S203: Divide the target container into at least two regions based on the grouping processing result. One object group corresponds to one region.

S204: Add the N resource objects to the target container according to a corresponding relationship between the object groups and the regions.

In step S203 and step S204, based on a grouping process of the resource objects by the computing device, the computing device may divide the target container with reference to the grouping processing result of the resource objects by the computing device when dividing the target container. In a specific implementation, the computing device may determine a division policy for the target container according to the length-width ratio of the target container first, for example, the determined division policy is a horizontal division policy or a vertical division policy. After the division policy is determined, the computing device may determine a final division position based on the area ratio of the cumulative area of the object groups obtained after grouping the resource objects. Further, the computing device may divide the target container in combination with the determined division policy and division position.

For example, the computing device determines to use the vertical division policy when the length of the target container is greater than the width, or to use the horizontal division policy when the length of the target container is less than or equal to the width. Assuming that the division policy determined by the computing device is the horizontal division policy, if the grouping processing result obtained by performing object grouping processing on the resource objects by the computing device is that the cumulative area of one object group accounts for 60% of the cumulative area of all resource objects and the cumulative area of the other object group accounts for 40% of the cumulative area of all resource objects, when the computing device performs horizontal division on the target container, a left region obtained by horizontal division will also account for 60% of the total area of the target container and a right region will also account for 40% of the total area of the target container, and the region accounting for 60% of the total area corresponds to the object group with the cumulative area accounting for 60% of the cumulative area of all resource objects and the region accounting for 40% of the total area corresponds to the object group with the cumulative area accounting for 40% of the cumulative area of all resource objects. In this way, on one hand, each region obtained by dividing the target container may be ensured not to be too long and narrow as much as possible, and on the other hand, the uniformity of distribution of the resource objects in different regions may also be ensured as much as possible.

Based on the grouping processing result of the plurality of resource objects and the plurality of regions obtained by dividing the target container, it can be known that one object group corresponds to one region of the target container, the resource objects in one object group are added to the corresponding region of the target container when the computing device adds the resource objects subsequently, that is, a process of adding the N resource objects acquired to the target container by the computing device is a process of adding the resource objects in each object group to the corresponding region of the target container according a corresponding relationship between the object groups and the regions.

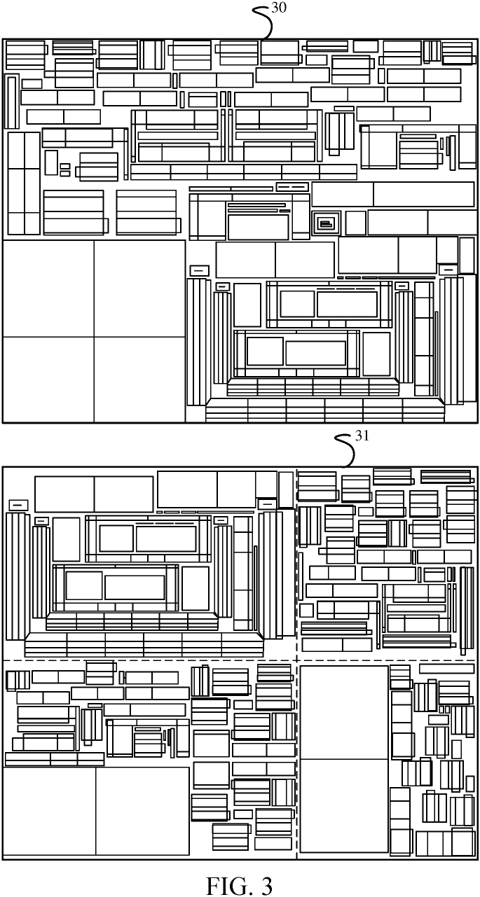

Practice shows that the computing device may achieve a good acceleration effect by packing the N resource objects based on the corresponding relationship between the object groups and the regions. If a quantity of the resource objects to be added to the target container is 801 (that is, the value of N is 801), according to an experimental result, the running time of adding the 801 resource objects to the target container by the computing device is 965 s and the filling rate is 99% in a scenario of not using the grouping policy. A result of adding the 801 resource objects to the target container in a scenario of not using the grouping policy may be as shown in the schematic diagram marked by 30 in FIG. 3. The running time is reduced to 93 s and the filling rate is reduced to 96% even if the computing device serially adds the plurality of object groups to the corresponding region in a scenario of using the grouping policy, as shown in the schematic diagram marked by 31 in FIG. 3. It can be seen that the filling rate for the target container will decrease due to gaps between different regions of the target container after the grouping policy is used. However, the filling rate still meets the filling details for the target container. Meanwhile, the running time after the grouping policy is used is reduced to 10% compared with the original time taken in the scenario of not using the grouping policy. It can be seen that the filling time of the resource objects can be effectively reduced on the basis of ensuring certain filling rate for the target container based on the grouping of the resource objects and the region portioning processing of the target container by the computing device, thereby improving the packing efficiency.

As shown in the schematic diagram marked by 31 in FIG. 3, the computing device may divide the 801 resource objects into four object groups and correspondingly divide the target container into four regions in a scenario of using the grouping policy. The manner of dividing the target container into four regions may be as shown in dashed lines in the schematic diagram marked by 31 in FIG. 3. The computing device may add the resource objects in each object group to the corresponding region based on the grouping of the resource objects and the region division of the target container.

Since the existing computing device is configured with multi-core computing resources, in order to further improve the resource use efficiency of the computing device and improve the packing efficiency for the resource objects, the computing device may perform parallel packing on the grouped resource objects after completing the grouping of the resource objects and the division of the target container. That is, the computing device may perform packing on the resource objects by using a parallel adding processing flow based on the multi-core computing resources and the corresponding relationship between the object groups and the regions, to further improve the efficiency of adding the resource objects to the target container by the computing device.

In one embodiment, the computing device may determine a specific manner used for parallel adding based on a parallel processing mechanism provided by an operating system of the computing device when adding the resource objects in each object group to the corresponding region by using a parallel adding processing flow. If the operating system in the computing device is a Linux operating system, the Linux operating system provides two parallel processing mechanisms, namely a multi-process parallel mechanism and a multi-thread parallel mechanism. The multi-process parallel mechanism refers to that: When the computing device adds any object group to the corresponding region, the operating system will independently create a process for performing, and data cannot be shared between the processes for adding the resource objects in different object groups to the corresponding regions. The multi-thread parallel mechanism refers to: When the computing device adds any object group to the corresponding region, a corresponding thread is created for performing, and the threads for adding the resource objects in different object groups to the corresponding regions belong to the same process. When taking the multi-process parallel mechanism as the parallel processing mechanism, the computing device may create a plurality of independent threads to perform a process of adding the resource objects of each object group. When taking the multi-thread parallel mechanism as the parallel processing mechanism, only one process may be created, the process of adding the resource objects of each object group is performed by a plurality of threads generated by the one process created. Various threads cannot share data, and the various threads belonging to the same process may share data. When the computing device selects the parallel processing mechanism, it may be determined by combining the importance of sharing data in a parallel process and the capabilities of processing resources of the computing device to create a thread and a process.

In addition, the Linux operating system also provides a plurality of data exchange manners such as a pipe data exchange manner, a temporary file data exchange manner, and a common file data exchange manner. The pipe data exchange manner refers to that: in the Linux system, data communication between a child process and a parent process is realized by using a pipe (PIPE). The temporary file data exchange manner refers to that: in the Linux system, data communication between a child process and a parent process is realized by using a temporary file; an mkstemp function (a temporary file processing function) and a tmpfile function (another temporary file processing function) used for processing the temporary file are also defined in the Linux system. The common file data exchange manner refers to that: data communication between a child process and a parent process is realized by using a file customized by an engineer, and the engineer may customize a file format and a read-write manner. The computing device may also determine a used parallel processing mechanism in combination with the data exchange manner provided by the operating system in the computing device. The computing device may use four different parallel adding processing flows when adding the resource objects in each object group to the corresponding region by using a parallel adding processing flow based on the parallel processing mechanism and the data exchange manner provided by the operating system and based on a specific details of an implementation scenario of the embodiment of the present disclosure. The four parallel adding processing flows, and the advantages and disadvantages when the computing device uses each parallel adding processing flow may as shown in Table 1:

TABLE 1

| Solution | Grouping policy | Parallel mechanism | Data exchange manner | Advantages | Disadvantages |
|---|---|---|---|---|---|
| 1 | Recursive grouping | Multi-process | Pipe | A program runs stably and there is no redundant file generated in an intermediate process | There are restrictions on the size of the pipe, and a user may acquire administrator privileges if the restrictions are to be modified |
| 2 | Recursive grouping | Multi-process | Temporary file | There is no restriction on the size of data | A program runs unstably and an implementation process is complex |
| 3 | Pre-grouping | Multi-thread | Temporary file | A program runs stably and there is no restriction on the size of data exchange | In pre-grouping, packing space cannot be segmented thoroughly due to an individual long and narrow polygon |
| 4 | Recursive grouping | Multi-process | Temporary file | A program runs stably, there is no restriction on the size of data exchange, and grouping may be performed flexibly and autonomously in subspace | A temporary file will be generated (but it may be automatically deleted after the running of the program) |

Recursive grouping refers to that: When a current input space (used for performing packing processing on resource objects) is obtained, whether the current input space may be grouped is determined first. The computing device will directly attempt to pack in the current input space and return a packing result if the current input space does not may be grouped. The current input space is divided into two subspaces if the current input space may be grouped, and the two subspaces are respectively processed in the same manner. Pre-grouping refers to that: The entire space is divided to form a plurality of final subspaces first, each subspace is subjected to packing in a serial or parallel manner, and finally, a result is returned. As shown in Table 1 above, when the computing device uses solution 1 to perform the parallel adding processing flow on the resource objects in each group object and after the computing device obtains the current input space, since the resource objects are divided into a plurality of object groups, the computing device may divide the current input space into two subspaces first, use the same manner until the current input space is divided into a plurality of subspaces. One subspace is used for performing packing processing on the resource objects in one object group. Further, the computing device will create a process for each subspace to process the packing problem of the object group corresponding to the subspace after the current input space is divided into a plurality of subspaces. Based on a recursive grouping manner for each subspace, if a certain subspace is divided into a first subspace and a second subspace, the process created by the computing device in the certain subspace is a parent process, and the processes created in the first subspace and the second subspace are child processes of the parent process. In addition, since the process of each subspace will generate, after packing the resource objects in the corresponding subspace, a corresponding intermediate file to record packing positions of the resource objects in the corresponding subspace, the computing device may realize the reading of the intermediate file in the child process by the parent process through a pipe, to obtain a final result file. The computing device may perform the parallel adding processing flow on the resource objects in each object group by using solution 2, solution 3, or solution 4 in a similar way.

In one embodiment, the computing device may determine a specific flow used when adding the resource objects in each object group to the corresponding region from the four parallel flows as shown in Table 1 based on actual capabilities and details of the device, that is, the computing device may also perform the parallel adding processing flow on the resource objects in each object group by using any policy in solutions 1 to 4 shown in Table 1. Based on the comparison of the advantages and disadvantages of different parallel adding processing flows shown in Table 1, in a scenario, the computing device may add the resource objects in each object group to the corresponding region in parallel by using solution 4 in Table 1.

In the embodiment of the present disclosure, after acquiring resource objects that are to be added to a target container and are greater than a threshold, the computing device may perform grouping processing on the plurality of resource objects acquired first to divide the plurality of resource objects into a plurality of different object groups. The computing device may perform grouping processing based on a scenario of similar cumulative area of each object group when preforming grouping processing on the plurality of resource objects, to effectively prevent the resource objects with large area from being divided into the same object group, thereby facilitating smoothly adding the resource objects in each object group into the target container subsequently. In addition, the computing device may also perform region division on the target container based on the grouping processing result of the resource objects to obtain a region corresponding to each object group, and the computing device may add the plurality of resource objects acquired to the corresponding regions according to a corresponding relationship between the object groups and the regions. Based on the grouping processing of the resource objects and the division of the target container by the computing device, the computing device may use a manner of adding each object group to the corresponding region when adding a large quantity of resource objects acquired to the target container subsequently, so that the adding efficiency for the resource objects can be effectively improved on the basis of ensuring certain filling rate of the computing device to the target container.

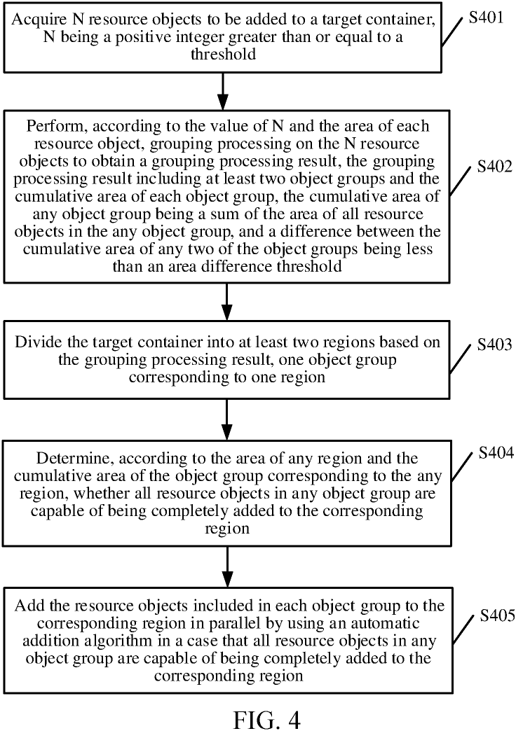

The grouping processing process for the resource objects and the division processing process for the target container shown in FIG. 2, and the process of adding the resource objects based on the corresponding relationship between the object groups and the regions are described in detail below in combination with the object processing method provided by FIG. 4. The method may include:

S401: Acquire N resource objects to be added to a target container. N is a positive integer greater than or equal to a threshold.

S402: Perform, according to the value of N and the area of each resource object, grouping processing on the N resource objects to obtain a grouping processing result. The grouping processing result includes at least two object groups and the cumulative area of each object group. The cumulative area of any object group is a sum of the area of all resource objects in the any object group. A difference between the cumulative area of any two of the object groups is less than an area difference threshold.

In step S401 and step S402, after the computing device acquires the N resource objects, the computing device determines, in response to that the value of N is greater than or equal to a threshold, that a quantity of the acquired resource objects is large, and may perform grouping processing on the acquired resource objects. The threshold may be 100, 200, or the like.

Since the value of N is used for describing a target scale range that the N resource objects belong, and one scale range is associated with one group quantity, the computing device may determine the target scale range of the resource objects according to the value of N first when performing grouping processing on the N resource objects according to the value of N and the area of each resource object, and acquire a target group quantity M associated with the target scale range. The target group quantity M is a total quantity of the at least two object groups included after the grouping processing is performed on the N resource objects. Further, the computing device may divide the N resource objects into the M object groups according to the area of each resource object, and perform summation processing on the area of all resource objects included in each object group to obtain the cumulative area of each object group. One object group includes at least one resource object, and M is a positive integer greater than or equal to 2 and less than or equal to N.

In one embodiment, when the computing device divides the N resource objects into the M object groups according to the area of each resource object, the computing device may perform descending sorting on the N resource objects according to the size of the area, and determine reference cumulative area of the resource objects included in any of the M object groups, so that the computing device may select a resource object in sequence according to the descending sorting, and determine an object group to which the selected resource object is divided according to the reference cumulative area to divide the N resource objects into the M object groups.

For example, when the value of M is 2, the computing device may perform grouping processing on the N resource objects acquired, and obtain two corresponding object groups (the two object groups may be respectively marked as a first object group and a second object group). Then, the following steps (1) to (3) may be performed when the computing device divides the N resource objects acquired to the two object groups:
(1) performing descending sorting on the resource objects to be grouped according to the area;
(2) setting two object groups, which respectively include a first object group A and a second object group B, respectively recording the reference cumulative area of the resource objects included in the two object groups, and assuming that the reference cumulative area of the first object group is marked as S_{A}, and the reference cumulative area of the second object group is marked as S_{B}; and
(3) for any resource object after sorting, dividing it into the first object group A in response to that S_{A}<S_{B} at current, or dividing it into the second object group B in response to that S_{A}≥S_{B} at current, and respectively updating S_{A} and S_{B}.

S403: Divide the target container into at least two regions based on the grouping processing result. One object group corresponds to one region.

When dividing the target container into at least two regions based on the grouping processing result, the computing device may acquire the cumulative area of each object group from the grouping processing result first, determine the area ratio of the cumulative area between the object groups according to the cumulative area of each object group, acquire a division policy for the target container, and determine a division position according to the division policy and the area ratio when division processing is performed on the target container. The area ratio between the two regions obtained by dividing is the same as the area ratio of the cumulative area between the object groups.

Further, the computing device may acquire a length-width ratio of the target container when determining the division policy for the target container, and use a vertical division policy in response to that the length-width ratio is greater than 1, or use a horizontal division policy in response to that the length-width ratio is less than or equal to 1. The horizontal division policy refers to dividing the target container into at least two regions in an upper-lower relationship, and the vertical division policy refers to dividing the target container into at least two regions in a left-right relationship. In other implementations, the horizontal division policy may also refer to dividing the target container into at least two regions in an upper-lower relationship, and the vertical division policy may also refer to dividing the target container into at least two regions in a left-right relationship. In the embodiment of the present disclosure, no limits are made to a specific division manner indicated by the division policy. After the computing device divides the target container into at least two regions according to the determined division policy and the division position, one region obtained by dividing corresponds to one object group in an equal ratio.

The computing device may also use a manner of combining the horizontal division and vertical division when dividing the target container. That is, the computing device may divide, based on area distribution of the resource objects included in each object group obtained by grouping the resource objects, the target container into a plurality of regions in the manner of combining the horizontal division and the vertical division for the target container, so that a matching degree between the region obtained by dividing and the resource objects to be added is high, thereby effectively improving the efficiency of adding the resource objects in any object group to the corresponding region subsequently.

In one embodiment, after the computing device obtains a plurality of object groups by performing grouping processing on the resource objects and dividing the target container into a plurality of regions, the computing device may add the resource objects in each group to the corresponding region in sequence in a serial adding manner. In certain embodiment(s), when the computing device adds the resource objects in a serial adding manner, the computing device may select one object group each time from the plurality of object groups obtained by grouping, add the resource objects in the selected object group to the corresponding regions, and select another object group, and add the resource objects in the another object group selected. The steps are cycled in this way until each object group is selected and subjected to a process of adding the resource objects.

In one embodiment, in order to further improve the efficiency of adding the resource objects, the computing device may also add the resource objects in each object group to the corresponding region in a parallel adding manner. In certain embodiment(s), when adding the resource objects in each object group in a parallel adding manner, the computing device create a plurality of child processes (or processes) and invoke each child process to add the resource objects in one object group, to add the resource objects in a plurality of object groups obtained by dividing to the corresponding regions. When the computing device adds the resource objects in each object group to the corresponding region in the parallel adding manner, whether the resource objects in each object group are capable of being added to the corresponding region may be determined first. The computing device may add the resource objects in each object group to the corresponding region in the parallel adding manner in response to that the resource objects in each object group are determined to be capable of being added to the corresponding region.

In one embodiment, in response to that there is a resource object that is incapable of being added to the corresponding region and that is in one object group in the plurality of object groups grouped by the computing device, the computing device may cancel the grouping processing performed on the N resource objects and region division performed on the target container, and add the N resource objects to the target container by using an automatic addition algorithm until an add stop condition is triggered. That is, in a scenario of determining that there is a resource object that is incapable of being added to the corresponding region and that is in a certain object group in the plurality of object groups obtained by performing grouping processing on the resource objects, the computing device adds, according to a determined sequence of adding the N resource objects to the target container, the N resource objects acquired by using an ungrouping policy to the target container in sequence until the add stop condition is triggered. The add stop condition refers to that: if there is one or more resource objects not added, any resource object not added is incapable of being added to a remaining region for adding the resource object in the target container in a scenario of not obstructing the resource object that has been added to the target container.

That is, in a scenario of determining that the resource objects in a certain object group are incapable of being added to the corresponding region, the computing device may end recursive division process of the target container, and directly perform packing processing on the acquired resource objects in sequence, to ensure that the resource objects are added to the target container as many as possible, and improve the packing effect of the computing device for the resource objects.

In some scenarios, the appearance of some object groups incapable of being added to the corresponding regions may be caused by the existence of a resource object in a target shape (for example, a long and narrow polygon) in the object group. On this basis, the computing device may determine whether there is a resource object in a target shape in the N resource objects acquired first after determining that there is an object group incapable of being added to the corresponding region, and attempt to perform appropriate segmentation on the resource object in the target shape when it is determined that there is the resource object in the target shape, thereby performing subsequent resource object grouping processing on the resource object (or polygon) after segmentation processing.

In one embodiment, if all polygons after segmentation may be added to the corresponding regions, the computing device may further perform recursive division on the target container, which can avoid the influence on a division result for the target container caused by a shape of an individual polygon, thereby improving the acceleration effect of grouping parallelization. However, if the computing device fails to segment the resource object in the target shape, or there is still a resource object incapable of being added to the corresponding region in the object group after segmentation, the acquired resource object may be directly added to the target container by using the ungrouping policy.

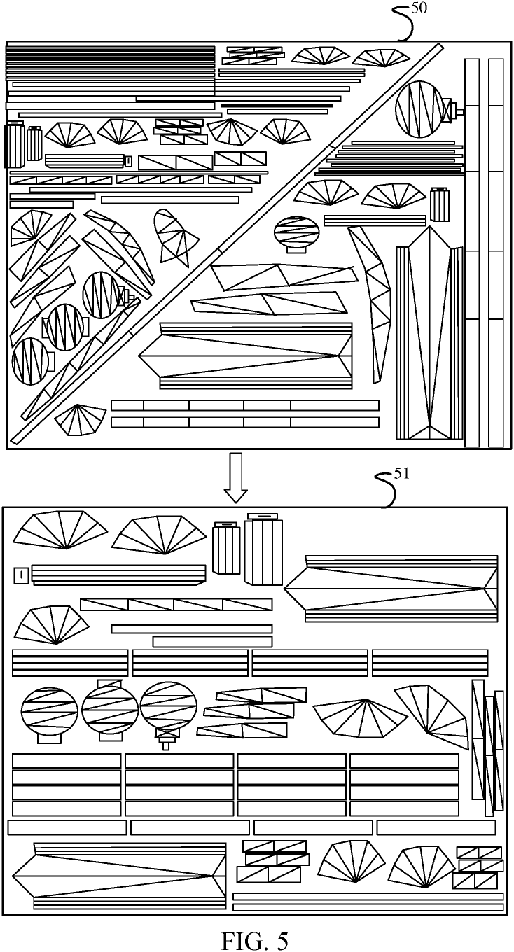

A process of performing recursive division on the target container refers to that the computing device may divide each object group obtained into two groups first when dividing the target container to obtain a plurality of regions, to divide the target container into two reference regions first based on the cumulative area of resource objects included in each group. One reference region divided corresponds to one object group. Then, the computing device may further divide the obtained reference region based on the ratio of the cumulative area of each object group corresponding to each reference region after the computing device determines that the resource objects in the corresponding object group are capable of being added to the corresponding reference regions, thereby dividing the target container into a plurality of regions. In response to that there is a resource object in the target shape, the computing device adds a plurality of resource objects to the target container before dividing the resource object in the target shape, which may be shown as the schematic diagram marked by 50 in FIG. 5, and adds the plurality of resource objects to the target container after dividing the resource object in the target shape, which may be shown as the schematic diagram marked by 51 in FIG. 5.

S404: Determine, according to the area of any region and the cumulative area of the object group corresponding to the any region, whether all resource objects in any object group are capable of being added to the corresponding region.

S405: Add the resource objects included in each object group to the corresponding region in parallel by using an automatic addition algorithm in response to that all resource objects in any object group are capable of being added to the corresponding region.

In step S404 and step S405, the computing device may add the resource objects included in each object group to the corresponding region in parallel in response to that the computing device determines that various object groups obtained by performing grouping processing on the resource objects are capable of being added to the corresponding region. In one embodiment, when determining whether the resource objects in each object group are capable of being added to the corresponding region, the computing device may determine through the cumulative area of the resource objects included in the object group and the region area of the corresponding region. When the cumulative area of the object group is less than or equal to the region area, the computing device may consider that the resource objects in the object group are capable of being added to the corresponding region. In addition, each resource object may be added to the target container after being scaled. Therefore, when determining whether the resource objects in each object group are capable of being added to the corresponding region, the computing device may scale each resource object in each object group in a certain proportion and calculate the cumulative area of each scaled resource object, and the computing device may determine that the resource objects in the object group are capable of being added to the corresponding region when the cumulative area of the scaled resource object is less than the region area of the corresponding region. A scaling proportion determined by the computing device for the resource target may be 60% or 70%. It is to be understood that the resource objects in each object group acquired by the computing device may be placed in the corresponding region in a scenario (that is, a scenario that the resource object in the target shape is not included) based on the manner of adding the resource object to the target container after scaling.

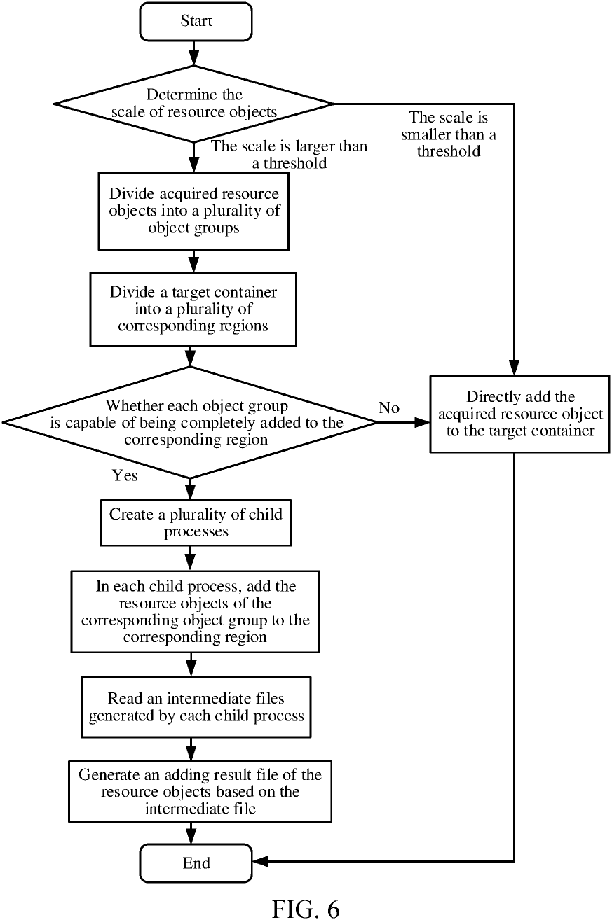

After the computing device determines that the resource objects included in each object group are capable of being added to the corresponding region, the computing device may create a new child process if the computing device determines to use the parallel adding flow of solution 4 in Table 1 to perform adding processing on each object group, and the computing device realize a parallel adding flow for each object group by performing packing processing on each region in the new child process. A process of adding the acquired resource objects to corresponding regions in parallel by the computing device is described below comprehensively with reference to FIG. 6:
1) acquiring resource objects, and determining the scale of the acquired resource objects (that is, determining whether a value of a quantity N of the acquired resource objects is greater than a threshold, which may be assumed as 100 or the like), and performing step 2) in response to that the value does not exceed the threshold, or performing step 3) in response to that the value exceeds the threshold;
2) directly adding the acquired resource objects to the target container by using an automatic addition algorithm, writing an adding result to an adding result file, and ending the algorithm;
3) dividing the acquired resource objects into a plurality of object groups by using the grouping policy, and dividing the target container into regions corresponding to various object groups;
4) determining whether the resource objects in each object group are capable of being added to the corresponding region, and performing step 2) in response to that the resource objects in each object group are capable of being added to the corresponding region, or performing step 5) in response to that the resource objects in each object group are incapable of being added to the corresponding region;
5) creating a plurality of child processes, and recursively invoking the automatic addition algorithm to add the corresponding object group to the corresponding region in each child process, one child process being used for adding the resource objects included in one object group to one corresponding region; and
6) after the running of all child processes is ended, invoking a parent process to reach an intermediate file generated by each child process and to merge the intermediate files to generate an adding result file that the N resource objects are added to the target container, and ending the flow after generating the adding result file and deleting the intermediate files.

In one embodiment, the automatic addition algorithm is an automatic packing algorithm based on NoFitPolygon (NFP) and a scenario of lowest center of gravity. The NFP refers to an adding feasible region, that is, a polygon formed by a trajectory of a certain reference point on a boundary of one polygon when sliding along an inner wall of the other polygon. The NFP defines, when one polygon (that is, the resource object) is added to a region defined by the other polygon (that is, the target container), a feasible region where the reference point of the one polygon is placed.

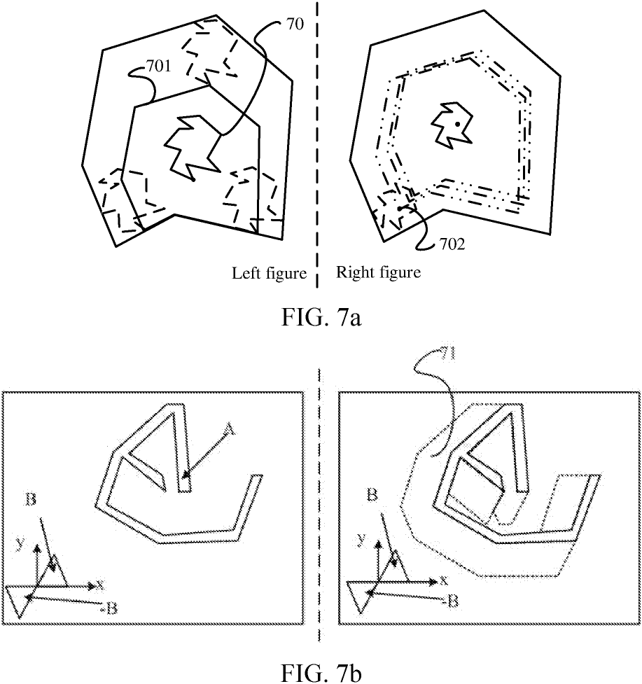

The overall framework of the automatic addition algorithm is described below with reference to FIG. 7a:

1) An adding sequence of the resource objects included in any object group is determined based on a genetic algorithm.

The genetic algorithm is a computational model simulating natural selection of Darwinian biological evolution and a biological evolution process of a genetic mechanism, and is a method for searching an optimal solution by simulating a natural evolution process. The algorithm converts a problem solving process into a process similar to the crossover and mutation of chromosomal genes in biological evolution by using a computer simulation operation in a mathematical manner. Better adjustment results can usually be obtained quickly compared with some other adjustment algorithms when solving complex combinatorial adjustment problems. In the embodiment of the present disclosure, the computing device may acquire a plurality of adding sequences for various resource objects in any object group, to perform pros and cons reduction calculation on the plurality of acquired adding sequences through the genetic algorithm to determine an optimal sequence for adding the resource objects.

2) A resource object is selected in sequence based on the adding sequence to serve as an object to be added (as the polygon marked by 70 in FIG. 7a), and at least one candidate angle when the object to be added is added to the corresponding region is determined.

3) An adding feasible region (as the polygonal region marked by 701 in FIG. 7a) corresponding to the any candidate angle is determined, and the adding feasible region is used for indicating a center of gravity corresponding to the object to be added after the object to be added is added to the corresponding region by using any candidate angle.

4) The object to be added is added to a position with a lowest center of gravity in the corresponding region, and a remaining region supporting resource object adding in the corresponding region is updated until all resource objects included in the any object group are added to the corresponding region.

In one embodiment, since there are a plurality of candidate angles corresponding to each object to be added, the corresponding adding feasible regions (that is, the NFP) of the object to be added are different at different candidate angles. Different NFPs determined based on different candidate angles of the object to be added may be shown as a plurality of dotted line polygon regions in a right figure of FIG. 7a. The computing device may determine the position with the lowest center of gravity based on the plurality of NFPs determined by different candidate suburbs, so that the object to be added may be added to the position with the lowest center of gravity. The position with the lowest center of gravity selected by the computing device may be the position marked by 702 in FIG. 7a.

In one embodiment, the computing device may determine the NFP (that is, the adding feasible region) by using a calculation formula for Minkowski sum. In a specific implementation, the computing device slides the object to be added along a region boundary (for example, the region boundary may be a boundary marked by A in FIG. 7b) of the corresponding region to obtain a boundary sliding trajectory of the object to be added. The obtained boundary sliding trajectory is as shown in the region of the dashed box marked by 71 in FIG. 7b. Then, the computing device may perform mirror symmetry processing for a reference point of the object to be added based on a reference origin to obtain a mirror object of the object to be added. For example, the object to be added may be a triangle represented by B in FIG. 7b, and a mirror object of the object to be added is a triangle represented by -B in FIG. 7b. Then, the computing device may calculate the Minkowski sum of the mirror object and the region according to the boundary sliding trajectory, and determine the adding feasible region for the object to be added based on the Minkowski sum. The computing device calculates the Minkowski sum between the mirror object and the region, that is, calculating the Minkowski sum of A and -B. The calculation formula for the Minkowski sum of A and -B is as follows:

$$\text{A} + \left(- \text{B}\right) = \left\{\left(\text{a} + \left(- \text{b}\right)\right| \text{a} ∈ \text{A} , - \text{b} ∈ - \text{B}\right\}$$

Based on the calculated NFP, when the reference point of the resource object is located within the boundary sliding trajectory (as shown in the left figure in FIG. 7c), the computing device may indicate that the reference point is located within the adding feasible region. If the reference point is located outside the boundary sliding trajectory (as shown in the right figure in FIG. 7c), it indicates that the reference point is located outside the adding feasible region. When the reference point is located within the adding feasible region, the computing device determines that the selected object can be added to the corresponding position. When the reference point is located outside the adding feasible region, the computing device determines that the selected object cannot be added to the corresponding position.

In one embodiment, since the time for the computing device to calculate the NFP is in direct proportion to the quantity of polygons corresponding to the resource objects and the quantity of vertexes of the polygon corresponding to the target container, and the shape of the polygon also plays a crucial role in a packing process, that is, the simpler the shape of the polygon is, the faster the computing device calculates NFP, and the faster the packing speed is, it may be understood that the adding of the resource objects by the computing device is related to not only the quantity of the acquired polygons and but also the shape of the polygon. Therefore, the computing device may improve the calculation speed of the Minkowski sum in a manner of replacing an original polygon with an approximate polygon, that is, the computing device may perform simplification processing on the object to be added in a process of determining the adding feasible region of the object to be added based on the Minkowski sum, and calculate the Minkowski sum by using the simplified object to be added, thereby improving the calculation speed of the NFP. In one embodiment, since a packing result does not allow the existence of overlapping (but a tiny gap is allowed) between polygons, the area of the used approximate polygon cannot be smaller than that of the original polygon when the computing device calculates the Minkowski sum by using the approximate polygon instead of the original polygon, and the computing device may perform the simplification processing on the object to be added by using a simplification algorithm for a polygon with holes and non-decreasing area. The simplification algorithm used by the computing device includes the following one or more ideas:
1) deleting a concave vertex of the polygon corresponding to the object to be added;
2) simplifying a convex segment of the polygon corresponding to the object to be added as a vertex; and
3) performing similar processing on the concave vertex or convex segment in a hole.

The concave vertex refers to that, for adjacent segments (p, q) and (q, r) on a polygon, if a vertex (p, q, r) forms a right turn relationship, q is defined as the concave vertex. The vertex marked by 703 in FIG. 7d is a concave vertex, and the polygon after the concave vertex is deleted is shown by the polygon marked by 72 in FIG. 7d. For adjacent segments (p, q), (q, r), and (r, s) on a polygon, if both (p, q, r) and (q, r, s) form a left turn relationship, segment (q, r) is defined as a convex segment. Two waists of a trapezoid as shown in FIG. 7e are convex segments, and the polygon after the convex segments are converted into a vertex is shown by the polygon marked by 73 in FIG. 7e.

In one embodiment, in a parallel processing process of the computing device, each child process will exchange data with a parent process. Each child process will generate a corresponding intermediate file after adding resource objects included in one object group to a corresponding region. The intermediate file is used for recording adding positions of various resource objects included in one object group in the region. In order to avoid a large number of intermediate files remaining after the computing device adds the resource objects to the target container and save computing resources of the computing device, after the intermediate files generated by each child process by adding the resource objects included in one object group to the corresponding region by using an automatic addition algorithm are acquired, the computing device may perform merging processing on the intermediate files in a parent process when it is determined that the adding of the N resource objects to the target container is ended, generate an adding result file for the N resource objects based on the merging processing of the intermediate files, and delete the intermediate files. After the computing device deletes the intermediate files, the computing device may remain only one adding result file recording final packing results after adding the N resource objects acquired to the target container, and a user may acquire the packing results for a plurality of resource objects by only reading the final adding result file. In addition, the computing device may also release related resources after deleting the intermediate files, to effectively alleviate the pressure on the computing device and ensure subsequent calculation details of the computing device.

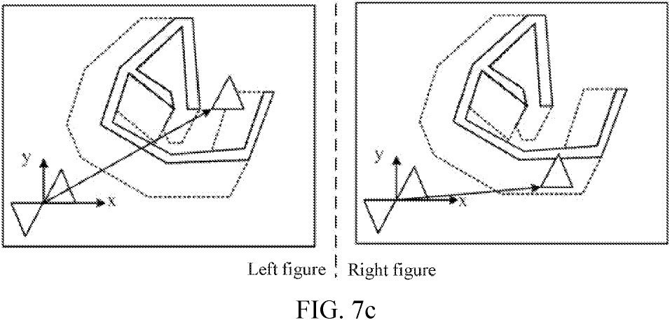

Based on the grouping parallelization means, the computing device may shorten the time for adding large-scale resource objects to the target container, so that the computing device can effectively improve the packing efficiency of the resource objects. However, the in order to further improve the parallelization efficiency of adding the resource objects in each object group to the corresponding region by the computing device to improve the parallelization processing efficiency of the computer on the whole, the computing device may perform pre-processing on the resource objects (that is, polygon coordinates corresponding to each resource object) in each object group by using a snap rounding skill. When the computing device performs pre-processing on the polygon coordinates by using the snap rounding skill, in order to ensure that the resource objects after being subjected to the snap rounding and added to the corresponding region of the target container do not overlap with the other resource objects, it requires to ensure that the area of the new resource object obtained is not less than that of the original resource object. Therefore, the computing device may perform pixel expansion processing on the original resource object before using snap rounding to obtain an approximate object of each resource object. In certain embodiment(s), the computing device may realize the pixel expansion processing on the original resource object in a manner of adding half a pixel distance on the basis of a bleeding value. As shown in FIG. 8, the resource object before the computing device performs the pixel expansion processing is shown as the polygon marked by 80 in FIG. 8, and the resource object obtained after the computing device performs the pixel expansion processing is shown as the polygon marked by 81 in FIG. 8. The computing device may further perform snap rounding to obtain a target resource object with limited precision after obtaining an approximate object of the resource object by using the pixel expansion processing. After obtaining the target resource object, the computing device may perform object group on the obtained target resource object. Practice shows that, after each resource object is pre-processed by using the snap rounding algorithm, the overall running time for the computing device to add the target resource object obtained after processing to the corresponding region is shorted by 20% compared with the overall running time before the pre-processing. The bleeding value refers to an interval between two different resource objects. Generally, one pixel bleeding value is taken every 128 pixels, for example, 2 pixel values are generally taken as the bleeding value in a resolution of 256x256. The snap rounding is a method for converting arbitrary precision permutation of a segment into fixed precision representation, which may be classified as a finite precision approximation technology in the research of robust geometric computation.

The computing device may obtain the efficiency of the computing device for packing large-scale resource objects by using the grouping parallelization in a Nest tool (a packing tool) of a 2UV project, which may be shown in Table 2:

TABLE 2

| Code | Quantity of resource objects | Ungrouping time consumption | Grouping serial time consumption (s) | Grouping parallel time consumption (s) |
|---|---|---|---|---|
| 1 | 1012 | 475 | 280 | 82 |
| 2 | 800 | 265 | 150 | 56 |
| 3 | 618 | Over half an hour | 1381 | 350 |
| 4 | 634 | Over half an hour | 495 | 225 |
| 5 | 402 | Over half an hour | 1018 | 45 |

As shown in Table 2, the larger the scale of the resource objects is, the more obvious the acceleration effect of packing after the computing device uses the grouping parallelization policy. On average, when the quantity of the resource objects exceeds 1000, if the computing device uses the grouping parallelization policy, the running time for the computing device to pack the resource objects may often be reduced below 20% of the original running time. In addition, by comparing the time consumption of several other typical grouping packing and parallelization methods, it can be found that after the computing device acquires larger-scale resource objects, the computing device can greatly improve the packing efficiency of the acquired resource objects no matter using the grouping policy or performing the parallelization policy on the basis of the grouping policy. The larger the quantity of the resource objects is, the more obvious the improvement effect of the efficiency is.

In the embodiment of the present disclosure, after acquiring larger-scale resource objects to be added to the target container, the computing device may divide the acquired resource objects into a plurality of object groups, and perform corresponding division on the target container based on a result obtained by performing grouping processing on the resource objects, so that one object corresponds to one region of the target container, and the resource objects in each object group may be added to the corresponding region in a parallel performing manner according to a corresponding relationship subsequently. Therefore, the larger-scale resource objects acquired are added to the target container. The parallelization processing manner used when the computing device adds the resource objects in each object group to the corresponding region can not only greatly reduce the recursion depth of the packing algorithm in each region to improve the running efficiency of a single region, but also make full use multi-core hardware resources in modern computers and further shorten the overall solution time of a large-scale packing problem by using the advantages of parallelization, thereby adding the large-scale resource objects to the target container quickly and efficiently.

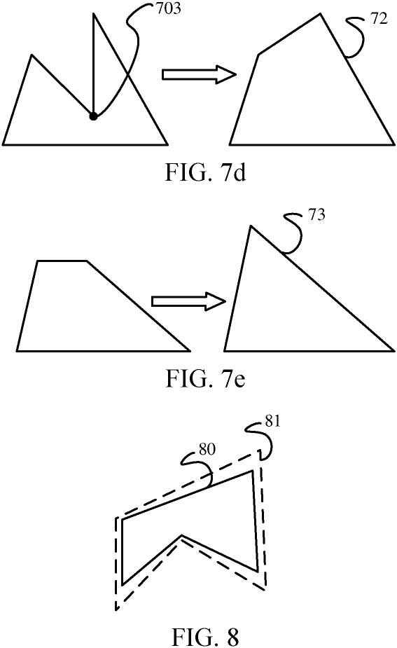

Based on the description of the object processing method embodiment, the embodiment of the present disclosure further provides an object processing apparatus. The object processing apparatus may be a computer program (including program code) running in the computing device. The object processing apparatus may be configured to perform the object processing method as described in FIG. 2 and FIG. 4. Referring to FIG. 9, the object processing apparatus includes: an acquisition unit 901, a processing unit 902, and an adding unit 903.

The acquisition unit 901 is configured to acquire N resource objects to be added to a target container. N is a positive integer greater than or equal to a threshold.

The processing unit 902 is configured to perform, according to the value of N and the area of each resource object, grouping processing on the N resource objects to obtain a grouping processing result. The grouping processing result includes at least two object groups and the cumulative area of each object group. The cumulative area of any object group is a sum of the area of all resource objects in the any object group. A difference between the cumulative area of any two of the object groups is less than an area difference threshold.

The processing unit 902 is further configured to divide the target container into at least two regions based on the grouping processing result. One object group corresponds to one region.

The adding unit 903 is configured to add the N resource objects to the target container according to a corresponding relationship between the object groups and the regions.

In one embodiment, the value of N is used for describing a target scale range that the N resource objects belong, and one scale range is associated with one group quantity. The processing unit 902 is configured to:
acquire a target group quantity M associated with the target scale range, the target group quantity M being a total quantity of the at least two object groups included after performing the grouping processing on the N resource objects; and
divide the N resource objects into the M object groups according to the area of each resource object, and perform summation processing on the area of all resource objects included in each object group to obtain the cumulative area of each object group. One object group includes at least one resource object, and M is a positive integer greater than or equal to 2 and less than or equal to N.

In one embodiment, the processing unit 902 is configured to:
perform descending sorting on the N resource objects according to the size of the area, and determine reference cumulative area of the resource objects included in any of the M object groups; and
select a resource object in sequence according to the descending sorting, and determine an object group to which the selected resource object is divided according to the reference cumulative area, to divide the N resource objects into the M object groups.

In one embodiment, in response to that the value of M is 2, the N resource objects are divided into a first object group and a second object group. The processing unit 902 is configured to:
determine to divide the selected resource object into the first object group in response to that the reference cumulative area of the resource objects included in the first object group is less than the reference cumulative area of the resource objects included in the second object group, or
divide the selected resource object into the second object group in response to that the reference cumulative area of the resource objects included in the first object group is greater than or equal to the reference cumulative area of the resource objects included in the second object group.

In one embodiment, the processing unit 902 is configured to:
acquire the cumulative area of each object group from the grouping processing result, and determine an area ratio of the cumulative area of the object groups according to the cumulative area of each object group;
acquire a division policy for the target container, and determine a division position according to the division policy and the area ratio when the division processing is performed on the target container, the area ratio between the two regions obtained by dividing being the same as the area ratio; and
divide the target container into at least two regions according to the determined division policy and the division position.

In one embodiment, the processing unit 902 is configured to:
acquire a length-width ratio of the target container; and
use a vertical division policy in response to that the length-width ratio is greater than 1, or use a horizontal division policy in response to that the length-width ratio is less than or equal to 1.

The horizontal division policy refers to dividing the target container into at least two regions in an upper-lower relationship, and the vertical division policy refers to dividing the target container into at least two regions in a left-right relationship.

In one embodiment, the adding unit 903 is configured to:
determine, according to the area of any region and the cumulative area of the object group corresponding to the any region, whether all resource objects in any object group are capable of being added to the corresponding region; and
add the resource objects included in each object group to the corresponding region in parallel by using an automatic addition algorithm in response to that all resource objects in any object group are capable of being added to the corresponding region.

In one embodiment, the adding unit 903 is configured to:
create a plurality of child processes, one child process being used for adding the resource objects included in one object group to one corresponding region; and
in each child process, respectively add the resource objects included in one object group to the corresponding region by using the automatic addition algorithm at the same time.

In one embodiment, the acquisition unit 901 is further configured to acquire an intermediate file generated after the resource objects included in one object group are added to the corresponding region by each child process by using the automatic addition algorithm. The intermediate file is used for recording adding positions of various resource objects included in one group object in the corresponding region.

The processing unit 902 is further configured to: perform, after the N resource objects are added to the target container, merging processing on the intermediate file in a parent process to generate an adding result file for the N resource objects, and delete the intermediate file.

In one embodiment, the processing unit 902 is further configured to: cancel the grouping processing performed on the N resource objects and region division performed on the target container in response to that there is a resource object included in one object group is incapable of being added to the corresponding region.

The processing unit 902 is further configured to add the N resource objects to the target container by using the automatic addition algorithm until an add stop condition is triggered.

In one embodiment, the processing unit 902 is further configured to: determine whether the N resource objects include a resource object in a target shape in response to that there is a resource objects in one object group incapable of being placed in the corresponding region.

The processing unit 902 is further configured to perform segmentation processing on the resource object in the target shape in response to that the N resource objects include the resource object in the target shape, and perform grouping processing on the resource object subjected to the segmentation processing.

The processing unit 902 is further configured to: trigger to perform the steps of canceling performing the grouping processing on the N resource objects and performing the region division on the target container in response to that the N resource objects do not include the resource object in the target shape.

In one embodiment, the processing unit 902 is configured to:
determine an adding sequence of the resource objects included in the any object group based on a genetic algorithm, and select a resource object in sequence as an object to be added based on the adding sequence;
determine at least one candidate angle in response to that the object to be added is added to the corresponding region, and add, according to an adding feasible region of the object to be added, a center of gravity after the object to be added is added by using any candidate angle to the corresponding region; and
add, according to the center of gravity, the object to be added to a position with a lowest center of gravity in the corresponding region, and update a remaining region supporting resource object adding in the corresponding region until all resource objects included in the any object group are added to the corresponding region.

In one embodiment, the processing unit 902 is further configured to: slide the object to be added along a boundary of the corresponding region to obtain a boundary sliding trajectory of the object to be added.

The processing unit 902 is further configured to perform mirror symmetry processing for a reference point of the object to be added based on a reference origin to obtain a mirror object of the object to be added.

The processing unit 902 is further configured to calculate a Minkowski sum of the mirror object and the region according to the boundary sliding trajectory, and determine an adding feasible region for the object to be added based on the Minkowski sum.

In one embodiment, it indicates that the reference point is located within the adding feasible region in response to that the reference point is located within the boundary sliding trajectory;
it indicates that the reference point is located outside the adding feasible region in response to that the reference point is located outside the boundary sliding trajectory; and
the selected object is allowed be added to a corresponding position in response to that the reference point is located within the adding feasible region, and the selected object is not allowed to be added to the corresponding position in response to that the reference point is located outside the adding feasible region.

In one embodiment, the processing unit 902 is configured to perform simplification processing on the object to be added in a process of determining the adding feasible region for the object to be added based on the Minkowski sum, and calculate the Minkowski sum by using the simplified object to be added.

The simplification processing includes at least one of the following: deleting a concave vertex of a polygon corresponding to the object to be added, and simplifying a convex segment of the polygon corresponding to the object to be added.

In one embodiment, the processing unit 902 is further configured to perform pixel expansion processing on any resource object in the N resource objects by using a snap rounding algorithm to obtain an approximate object of each resource object.

The processing unit 902 is further configured to perform grouping processing on the N resource objects by using the approximate object of each resource object.

In the embodiment of the present disclosure, after the acquisition unit 901 acquires resource objects that are to be added to a target container and are greater than a threshold, the processing unit 902 may perform grouping processing on the plurality of resource objects acquired first to divide the plurality of resource objects into a plurality of different object groups. The processing unit 902 may perform grouping processing based on a scenario of similar cumulative area of each object group when preforming grouping processing on the plurality of resource objects, to effectively prevent the resource objects with large area from being divided into the same object group, thereby facilitating smoothly adding the resource objects in each object group into the target container subsequently. In addition, the processing unit 902 may also perform region division on the target container based on the grouping processing result of the resource objects to obtain a region corresponding to each object group, and the adding unit 903 may add the plurality of resource objects acquired to the corresponding regions according to a corresponding relationship between the object groups and the regions. Based on the grouping processing of the resource objects and the division of the target container by the processing unit 902, a manner of adding each object group to the corresponding region may be used when adding a large quantity of resource objects acquired to the target container subsequently, so that the adding efficiency of a computing device for the resource objects can be effectively improved on the basis of ensuring certain filling rate for the target container.

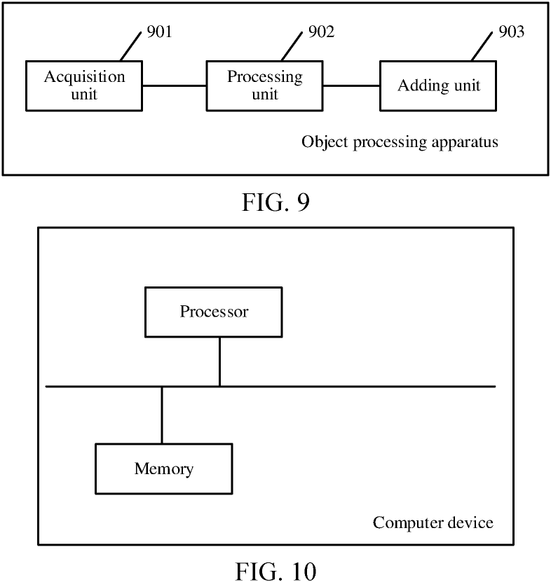

Refer to FIG. 10, which is a schematic block diagram of a structure of a computing device provided by an embodiment of the present disclosure. The computing device in this embodiment as shown in FIG. 10 may include: one or more processors and a memory. The processors are connected to the memory through buses. The memory is configured to store a computer-readable instruction. The processors are configured to execute the computer-readable instruction stored in the memory.

The memory may include a volatile memory such as a random-access memory (RAM). The memory may also include a non-volatile memory such as a flash memory, a hard disk drive (HDD), or a solid-state drive (SSD). The memory may further include a combination of the types of memories.

The processor may be a central processing unit (CPU). The processor may further include a hardware chip. The hardware chip may be an application-specific integrated circuit (ASIC), a programmable logic device (PLD) or a combination thereof. The PLD may be a field-programmable gate array (FPGA), a generic array logic (GAL), or the like. The processor may also be a combination of the structures.

In the embodiment of the present disclosure, the memory is configured to store a computer-executable instruction. The processor is configured to execute the computer-readable instruction stored in the memory to implement steps of the object processing method provided by the embodiment of the present disclosure.

The embodiment of the present disclosure provides a computer program product or a computer program. The computer program product or the computer program includes a computer-readable instruction. The computer-readable instruction is stored in a computer-readable storage medium. A processor of the computing device reads the computer-readable instruction from the computer-readable storage medium. The processor executes the computer-readable instruction, so that the computing device performs steps of the object processing method provided by the embodiment of the present disclosure. The computer readable storage medium may be a magnetic disk, an optical disc, a read-only memory (ROM), a random access memory (RAM), or the like.

The term unit (and other similar terms such as subunit, module, submodule, etc.) in this disclosure may refer to a software unit, a hardware unit, or a combination thereof. A software unit (e.g., computer program) may be developed using a computer programming language. A hardware unit may be implemented using processing circuitry and/or memory. Each unit may be implemented using one or more processors (or processors and memory). Likewise, a processor (or processors and memory) may be used to implement one or more units. Moreover, each unit may be part of an overall unit that includes the functionalities of the unit.

What is disclosed is merely partial embodiments of the present disclosure, and is not intended to limit the scope of rights of the present disclosure. A person of ordinary skill in the art may understand all or some flows that implement the embodiments, and equivalent modifications made according to the claims of the present disclosure still fall within the scope of the present disclosure.

What is claimed is:

1. An object processing method, performed by a computing device, the method comprising:
acquiring N resource objects to be added to a target container, N being a positive integer greater than or equal to a threshold;
performing, according to the value of N and the area of each resource object, grouping processing on the N resource objects to obtain a grouping processing result, the grouping processing result comprising at least two object groups and the cumulative area of each object group, the cumulative area of any object group being a sum of the area of all resource objects in the any object group, and a difference between the cumulative area of any two of the object groups being less than an area difference threshold;
dividing the target container into at least two regions based on the grouping processing result, one object group corresponding to one region; and
adding the N resource objects to the target container according to a corresponding relationship between the object groups and the regions.

2. The method according to claim 1, wherein the value of N describes a target scale range to which the N resource objects belong, one scale range is associated with one group quantity, and performing the grouping processing comprises:
acquiring a target group quantity M associated with the target scale range, the target group quantity M being a total quantity of the at least two object groups comprised after performing the grouping processing on the N resource objects,
dividing the N resource objects into the M object groups according to the area of each resource object, and performing summation processing on the area of all resource objects comprised in each object group to obtain the cumulative area of each object group, one object group comprising at least one resource object, and M being a positive integer greater than or equal to 2 and less than or equal to N.

3. The method according to claim 2, wherein dividing the N resource objects comprises:
performing descending sorting on the N resource objects according to the size of the area, and determining reference cumulative area of the resource objects comprised in any of the M object groups; and
selecting a resource object in sequence according to the descending sorting, and determining an object group to which the selected resource object is divided according to the reference cumulative area, to divide the N resource objects into the M object groups.

4. The method according to claim 3, wherein in response to that the value of M is 2, the N resource objects are divided into a first object group and a second object group, and determining the object group comprises:
determining to divide the selected resource object into the first object group in response to that the reference cumulative area of the resource objects comprised in the first object group is less than the reference cumulative area of the resource objects comprised in the second object group, or
dividing the selected resource object into the second object group in response to that the reference cumulative area of the resource objects comprised in the first object group is greater than or equal to the reference cumulative area of the resource objects comprised in the second object group.

5. The method according to claim 1, wherein dividing the target container comprises:
acquiring the cumulative area of each object group from the grouping processing result, and determining an area ratio of the cumulative area of the object groups according to the cumulative area of each object group;
acquiring a division policy for the target container, and determining a division position according to the division policy and the area ratio when the division processing is performed on the target container, the area ratio between the two regions obtained by dividing being the same as the area ratio; and
dividing the target container into at least two regions according to the determined division policy and the division position.

6. The method according to claim 5, wherein acquiring the division policy comprises:
acquiring a length-width ratio of the target container; and
using a vertical division policy in response to that the length-width ratio is greater than 1, or using a horizontal division policy in response to that the length-width ratio is less than or equal to 1,
the horizontal division policy referring to dividing the target container into at least two regions in an upper-lower relationship, and the vertical division policy referring to dividing the target container into at least two regions in a left-right relationship.

7. The method according to claim 1, wherein adding the N resource objects comprises:
determining, according to the area of any region and the cumulative area of the object group corresponding to the any region, whether all resource objects in any object group are capable of being added to the corresponding region; and
adding the resource objects comprised in each object group to the corresponding region in parallel by using an automatic addition algorithm in response to that all resource objects in any object group are capable of being added to the corresponding region.

8. The method according to claim 7, wherein adding the resource objects comprises:
creating a plurality of child processes, one child process being configured to add the resource objects comprised in one object group to one corresponding region; and
in each child process, respectively adding the resource objects comprised in one object group to the corresponding region by using the automatic addition algorithm at the same time.

9. The method according to claim 8, further comprising:
acquiring an intermediate file generated after the resource objects comprised in one object group are added to the corresponding region by each child process by using the automatic addition algorithm, the intermediate file recording adding positions of various resource objects comprised in one group object in the corresponding region; and
performing, after the N resource objects are added to the target container, performing merging processing on the intermediate file in a parent process to generate an adding result file for the N resource objects, and deleting the intermediate file.

10. The method according to claim 7, further comprising:
canceling the grouping processing performed on the N resource objects and region division performed on the target container in response to that there is a resource object comprised in one object group incapable of being added to the corresponding region; and
adding the N resource objects to the target container by using the automatic addition algorithm until an add stop condition is triggered.

11. The method according to claim 7, further comprising:
determining whether the N resource objects comprise a resource object in a target shape in response to that there is a resource objects in one object group incapable of being placed in the corresponding region;
performing segmentation processing on the resource object in the target shape in response to that the N resource objects comprise the resource object in the target shape, and performing grouping processing on the resource object subjected to the segmentation processing; or
triggering to perform the steps of canceling performing the grouping processing on the N resource objects and performing the region division on the target container in response to that the N resource objects do not comprise the resource object in the target shape.

12. The method according to claim 8, wherein adding the resource objects comprises:
determining an adding sequence of the resource objects comprised in the any object group based on a genetic algorithm, and selecting a resource object in sequence as an object to be added based on the adding sequence;
determining at least one candidate angle in response to that the object to be added is added to the corresponding region, and adding, according to an adding feasible region of the object to be added, a center of gravity after the object to be added is added by using any candidate angle to the corresponding region; and
adding, according to the center of gravity, the object to be added to a position with a lowest center of gravity in the corresponding region, and updating a remaining region supporting resource object adding in the corresponding region until all resource objects comprised in the any object group are added to the corresponding region.

13. The method according to claim 12, further comprising:
sliding the object to be added along a boundary of the corresponding region to obtain a boundary sliding trajectory of the object to be added;
performing mirror symmetry processing for a reference point of the object to be added based on a reference origin to obtain a mirror object of the object to be added; and
calculating a Minkowski sum of the mirror object and the region according to the boundary sliding trajectory, and determining an adding feasible region for the object to be added based on the Minkowski sum.

14. The method according to claim 13, wherein the reference point is located within the adding feasible region in response to that the reference point is located within the boundary sliding trajectory;
the reference point is located outside the adding feasible region in response to that the reference point is located outside the boundary sliding trajectory; and
the selected object is allowed be added to a corresponding position in response to that the reference point is located within the adding feasible region, and the selected object is not allowed to be added to the corresponding position in response to that the reference point is located outside the adding feasible region.

15. The method according to claim 13, further comprising:
performing simplification processing on the object to be added in a process of determining the adding feasible region for the object to be added based on the Minkowski sum, and calculating the Minkowski sum by using the simplified object to be added,
the simplification processing comprising at least one of the following: deleting a concave vertex of a polygon corresponding to the object to be added, and simplifying a convex segment of the polygon corresponding to the object to be added.

16. The method according to claim 1, further comprising:
performing pixel expansion processing on any resource object in the N resource objects by using a snap rounding algorithm to obtain an approximate object of each resource object; and
performing grouping processing on the N resource objects by using the approximate object of each resource object.

17. An object processing apparatus, comprising: a memory storing computer program instructions; and at least one processor coupled to the memory and configured to execute the computer program instructions and perform:
acquiring N resource objects to be added to a target container, N being a positive integer greater than or equal to a threshold;
performing, according to the value of N and the area of each resource object, grouping processing on the N resource objects to obtain a grouping processing result, the grouping processing result comprising at least two object groups and the cumulative area of each object group, the cumulative area of any object group being a sum of the area of all resource objects in the any object group, and a difference between the cumulative area of any two of the object groups being less than an area difference threshold;
dividing the target container into at least two regions based on the grouping processing result, one object group corresponding to one region; and
adding the N resource objects to the target container according to a corresponding relationship between the object groups and the regions.

18. The apparatus according to claim 17, wherein the value of N describes a target scale range to which the N resource objects belong, one scale range is associated with one group quantity, and performing the grouping processing includes:
acquiring a target group quantity M associated with the target scale range, the target group quantity M being a total quantity of the at least two object groups comprised after performing the grouping processing on the N resource objects,
dividing the N resource objects into the M object groups according to the area of each resource object, and performing summation processing on the area of all resource objects comprised in each object group to obtain the cumulative area of each object group, one object group comprising at least one resource object, and M being a positive integer greater than or equal to 2 and less than or equal to N.

19. The apparatus according to claim 17, wherein dividing the target container includes:
acquiring the cumulative area of each object group from the grouping processing result, and determining an area ratio of the cumulative area of the object groups according to the cumulative area of each object group;
acquiring a division policy for the target container, and determining a division position according to the division policy and the area ratio when the division processing is performed on the target container, the area ratio between the two regions obtained by dividing being the same as the area ratio; and
dividing the target container into at least two regions according to the determined division policy and the division position.

20. A non-transitory computer-readable storage medium storing computer program instructions executable by at least one processor to perform:
acquiring N resource objects to be added to a target container, N being a positive integer greater than or equal to a threshold;
performing, according to the value of N and the area of each resource object, grouping processing on the N resource objects to obtain a grouping processing result, the grouping processing result comprising at least two object groups and the cumulative area of each object group, the cumulative area of any object group being a sum of the area of all resource objects in the any object group, and a difference between the cumulative area of any two of the object groups being less than an area difference threshold;
dividing the target container into at least two regions based on the grouping processing result, one object group corresponding to one region; and
adding the N resource objects to the target container according to a corresponding relationship between the object groups and the regions.
